(19) United States
(12) Patent Application Publication
(10) Pub. No.: US 2017/0028511 A1
(43) Pub. Date: Feb. 2, 2017

(54) PERFORATED SUBSTRATE AND A METHOD OF MANUFACTURE

(71) Applicant: Lisit Pte Ltd, Singapore (SG)

(72) Inventors: Prapan Sieglinde, Malix (CH); Johannes Marx-Aurnhammer Werner, Singapore (SG)

(21) Appl. No.: 15/303,358

(22) PCT Filed: Apr. 9, 2014
(86) PCT No.: PCT/SG2014/000156

§ 371 Date: Oct. 11, 2016

(51) Int. Cl. B23K 26/382; H01M 2/16; B23K 26/18; H01M 2/18; H01M 10/0525; H01G 11/52; H01M 2/14

(52) U.S. Cl. CPC B23K 26/382; H01G 11/52; H01M 2/1653; H01M 2/145; H01M 2/18; H01M 10/0525; B23K 26/18; B23K 2201/36

(57) ABSTRACT

The present invention relates to an optimization of a perforated substrate and a method of manufacturing the substrate using a printing process. The method of manufacturing the perforated substrate involves a substrate which is printed with ink into black patterns via a printing cylinder. The ink is applied to the substrate with small microns inside the cylinder. The microns are fabricated using laser technology. These black patterns on the substrate are exposed to an infrared light, which creates holes within the substrate. The printed features control the flow of change through the substrate. The substrate can be used in different applications such as filters, membranes of electrical separators. Examples of applications of the material include lithium ion battery separator, capacitors, super capacitors, electrical components, Packaging for the F&B industry in the field of breathable packaging or perishable groceries, filter, micro filter, membranes, energy storage devices, and sailcloth.

### BACKGROUND OF THE INVENTION

The present invention relates to a process manufacturing perforated substrate primarily used in electrical devices. The perforated substrate can be used in a wide range of devices including battery separators and capacitors. The electrical separator could be possible used for any kind of electrical separation from anode to cathode. The characteristics also allow the usage in applications such as energy storage, food packaging and sailcloth.

Rechargeable batteries based on the lithium ion technology cell, which moves ions of a source electrode material between the anode and cathode are the primarily use of the perforated substrate. These secondary storage batteries do have a minimum of at least one pair of electrodes of opposite polarity, which are separated with materials such as fleece and ceramic, such as described in patent EP 0618629 A1.

One of the most critical elements of the battery design is the separator component. A good overview on separator technology is Battery Separators is provided in the article Battery separators (Arora and Zhang, 2004). This outlines the importance of the separator component whereby the invention manufactured and described as perforated substrate. The perforated substrate effects the characteristics such as charge flow, short-circuits, lifespan, charging time, cell temperature and capacity of the battery. Thus the implementation of the perforated substrate can be used to optimize the battery. The flow of the electrical particles is controlled with the substrate and perforated holes within. The characteristics of a separator must allow best possible flow to enhance battery performance.

The perforated substrate must be resistant to instability and degradation of the battery environment and chemistry. The perforated substrate must withstand the strong acidic environment under different temperatures present within the battery. The perforated substrate material must be thin and porous to provide the best possible density of electrical flow. The resultant porosity of the perforated substrate must be controlled so that the optimal configuration of holes based on the holes placement; pattern of holes, and hole sizes may be obtained. The perforated substrate must be capable of allowing a high degree of electrolytic conductivity, to achieve a low electrical resistance and thus a more efficient performance of the battery. The separator should be capable of inhibiting the formation of dendrites. Such dendrite formations occur due to operation of the battery when parts of the electrode material become dissolved in the electrolyte and, while passing through the perforated substrate. Deposits therein develop a formation, which can over time connect through the thickness of the separator membrane and cause an electrical short between the batteries electrodes of opposite polarity. Performance of separators are subjected to the characteristics of the material used, additional the folding is also important, as described in U.S. Pat. No. 3,097,975 A.

The separator element must have sufficient strength and constitution to perform in a number of different scenarios. It is important that the perforated substrate does not suffer tears or punctures during the battery assembly process. This will directly effect the tension of the substrate itself, and lead to short circuits and uncontrolled flow of the electrical particulars. Therefore the perforated substrate must be able to withhold mechanical stress. The thickness of the perforated substrate is important for facilitation of charge flow under the high energy and charge densities present within a device. To allow a long battery lifecycle, it is important that a uniform inclusion of elements in the perforated substrate submitted to the manufacturing process is achieved. Uneven spatial distribution in the inclusion of elements placed within the perforated substrate leads to an improper flow of electrolyzes within the electrical device, as well as a reduced ability for electrode contact prevention.

The perforated substrate must withstand the oxidative and reductive chemical environment within the battery, particularly during the period of time when fully charged and oxidation or reduction are at the highest rates. Failure in the structural integrity of the separator, such as the inclusion of a high numbers of electrolytes flowing through the battery separator impacts the power generation process within the battery, and makes the battery perform less efficiently. As example the flow pure size can be measured according to ASTM E-1294. This process is described in Patent WO2012162168 A1. The substrate used in the invention does fulfill these characteristics.

Current Lithium-Ion battery separator technologies are being developed with polyethylene (PE), polypropylene (PP), or laminates of polyethylene and polypropylene as the substrate. These substrates are made of polyolefin materials because they have characteristics such as improved chemical stability, mechanical properties and acceptable cost. These substrates are compatible with required cell chemistry, meaning that the storage device can be cycled several hundred times without significant decrease in chemical or physical properties. The manufacturing process can be broadly divided into dry and wet processes. Several process steps to increase the density and porosity are used such as melting polyolefin resin, extruding it into a substrate, thermally.

The current invention described an advance in battery separator technology, specifically for lithium ion batteries. In that a gravure-printing roll is implemented along with an optical imaging process. This method provides for two distinct advantages. Firstly, the manufacturing process is sufficiently simplified so that a variety of elements may be patterned onto the perforated substrate precursor resulting in a simpler method to process a thin film battery separator. Secondly, the method of manufacture is sufficiently flexible so that the optimal elements comprised within the print may be fabricated within the thin film perforated substrate. This results in an optimal perforated substrate structure that will then lead to an enhanced battery device when applied within the battery storage medium. The resultant perforated substrate is also applicable for use within other electrical devices. For example, it can control electrical flow in capacitors and other conductive devices. This way of manufacturing is economical beneficial in comparison to laser imposing of holes into substrates or other procedures.

### SUMMARY OF THE INVENTION

Broadly, the invention is directed towards the manner of manufacture of a perforated substrate. This perforated substrate is described to be optimizing a battery separator, used in lithium ion battery, and the optimal inclusion of elements. The method of manufacture of the perforated substrate involves a printing method whereby a variety of elements may be printed on the perforated substrate. Subsequent application of an exposure laser embeds the printed patterns into holes into the substrates.

In the present invention, a steel-printing cylinder is utilized for the manufacture of a thin perforated substrate. This steel-printing cylinder provides for the ease of manufacture and also for the inclusion of a variety of holes inclusions that can control the porosity of the perforated substrate manufactured. The control of the perforated substrate porosity and the pattern included in the perforated substrate is achieved through the implementation of laser imaging and the use of a fluid water based ink on the printing cylinder. The printing cylinder receives a copper electroplating and subsequently a laser marking. The thin film substrate through application of the printing cylinder with the fluid ink is then submitted to an exposure of laser light. The perforated substrate is thus promoted to include the patterned elements of the printing cylinder, with high accuracy and through an efficient manufacturing process.

The ability to control the printed pattern on the printing cylinder and subsequently the perforated substrate is achieved through the use of laser technology that uses direct laser engraver for embossing cylinder into microns. The particular pattern used for the manufacture of the battery separator is described. This pattern achieves the optimal control mechanism for the flow of charge, and thus improves the performance and various merits of the battery.

Current patent for perforated substrates do not have the range of the mentioned invention. The patent US20090169984 A1 for example includes only the range from 10 μm upwards, whereby the perforated substrate in the mentioned invention has a thickness range from 2 μm-50 μm.

### BRIEF DESCRIPTION OF THE DRAWINGS

FIG. 1 illustrates the process flow chart to manufacture the perforated substrate, inclusive process steps, material and products.

1.1 illustrates the cylinder production from the gravure cylinder with laser exposure into the print cylinder with microns.

1.2 illustrates the printing process where the substrate (PE) is embossed with the ink via the print cylinder, to create the substrate with patterns.

1.3 illustrates the laser exposure of the substrate with patterns to impose the patterns. The product is a perforated substrate.

FIG. 2 illustrates a gravure cylinder which is exposed to laser technology to embossing microns into the cylinder.

2.1 illustrates the wind direction of the cylinder

2.2 illustrates the row gravure cylinder with cupper layer

2.3 illustrates the laser head

2.4 illustrates the laser light which is exposed to the gravure cylinder

2.5 describes the microns

FIG. 3 illustrates the print process where the printing cylinder applies the water based ink onto the substrate. The patterns on the substrate result from the microns on the print cylinder.

3.1 illustrates the printing cylinder with microns

3.2 illustrates the printed substrate with the pattern

3.3 illustrates the micron in the cylinder with ink

3.4 illustrates printing direction

3.5 illustrates the substrate without print

FIG. 4 pictures the applied pattern on the substrate (PE).

The picture includes the dimension range of the patterns and the distance range between patterns.

FIG. 5 illustrates the process step whereby the substrate with the patterns is exposed to laser light; this result is a substrate with imposed patterns.

5.1 illustrates the substrate from printed to imposed

5.2 illustrates the printed pattern on the substrate

5.3 illustrates the imposed pattern on the substrate

5.4 illustrates the laser bar

5.5 illustrates the laser light exposed on the substrate

FIG. 6 pictures the thin film separator with imposed patterns on the substrate

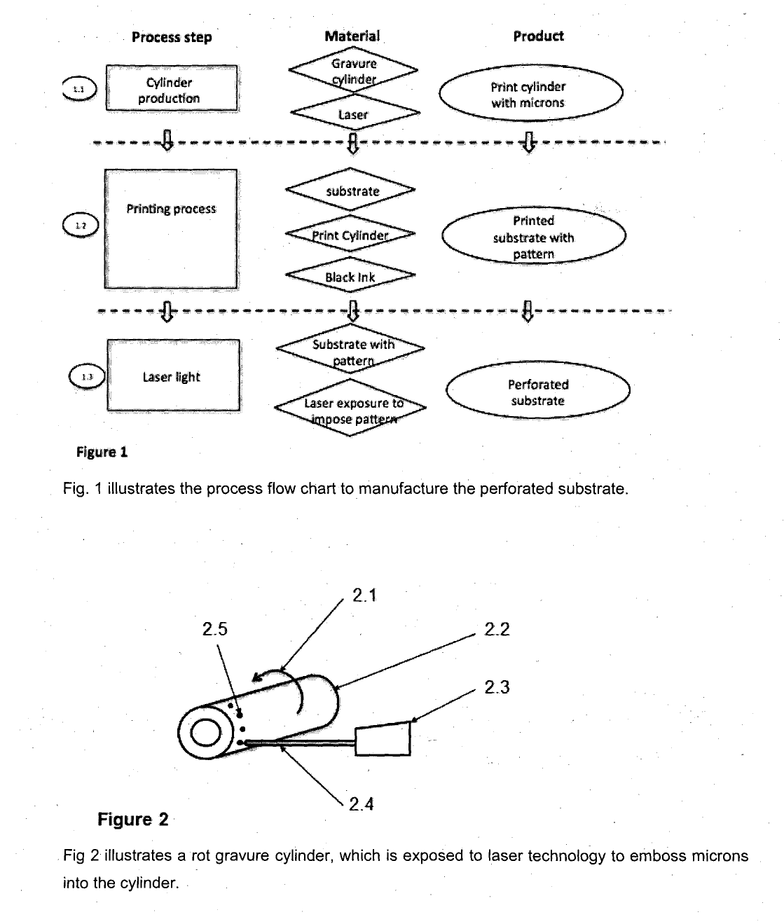

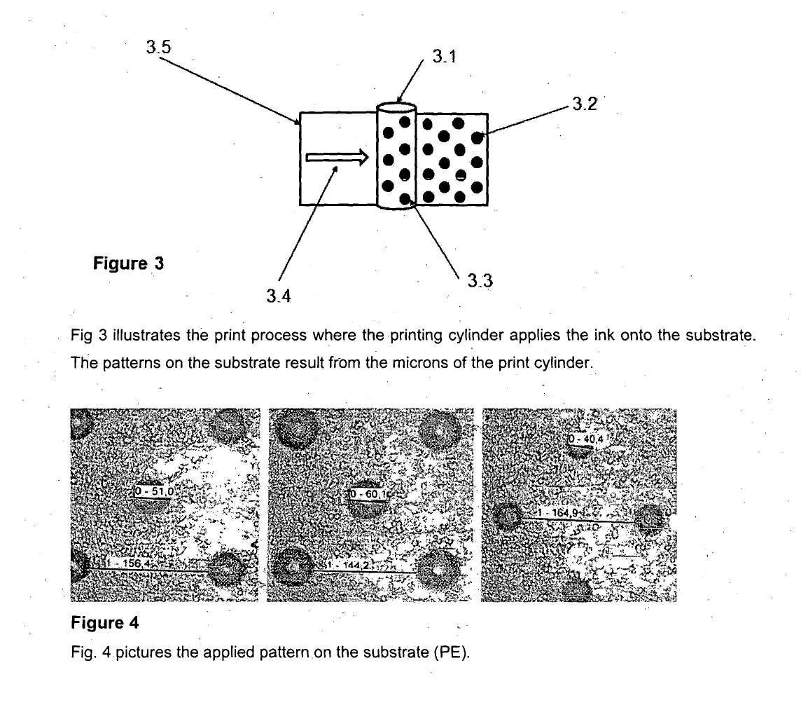

### PREFERRED EMBODIMENTS OF THE INVENTION

Description of the Process of Manufacture

The process of manufacturing a perforated substrate is split in three main steps. The comprising preparation of a printing cylinder, the application of an ink to the substrate with the said printing cylinder, and the subsequently exposing the ink pattern with laser light. The process starts with the process step (1.1) to transform a raw printing cylinder with microns. Therefore a raw standard gravure-printing cylinder which has copper layer applied, as shown in FIG. 2 (2.2). The cylinder (2.2) is manufactured with a hollow body and made of steel. After mechanical completion in steel, the steel roller (2.2) is plated with copper using an electroplating process resulting in an outer copper electroplating. A laser light (2.4) is then applied to the gravure-printing cylinder (2.2), which engraves microns (2.5) onto surface of the cylinder. A chrome layer is applied to protect the outer surface. The result is finished engraved gravure-printing cylinder. This is a standard process microns on the surface of printing cylinder, described embossing.

The next process step (1.2) describes the printing of the ink via the finished printing cylinder (3.1) onto the substrate (3.5). For this step a rotogravure printing machine or lamination machine with printing unit can be used. In the standard process the printing/lamination machine is used to apply the ink via the microns (3.3) from the gravure printing cylinder onto the substrate (3.5). The printing direction (3.4) displays the flow of the substrate through the printing/lamination machine. The finished substrate with the patterns (3.2) is the result of this process.

The last process step includes the use of an infrared laser bar to impose a pattern of holes on to the substrate by thermodynamic reaction of the printed ink patter. The process step with the laser light (1.3) describes that the finished substrate (5.1) with patterns (5.2) is exposed to a laser light (5.5) from the laser bar (5.4), which imposes the patterns into the substrate (5.3).

The result is the thin film electrical separator wherein the perforated substrate has a characteristic heat resistance in the range of up to 130-150 Celsius, a tension resistance in the range of 1 NM-50 NM, a thickness in the range of 2 μm-50 μm, an average hole density in a range of 500-10,000 per square centimeter, and an average hole diameter of 30 μm-90 μm. The perforated holes be suitably formed to conform to a variety of shapes.

Description of the Printing Cylinder

In FIG. 2 the manufacture of the finished print cylinder with embossing of microns is described. For the preparation of the cylinder a special laser system with a high resolution is used. The resolution of this laser system must be in the range from 2-12 microns. The raw gravure cylinder is a hollow body made of steel with or with shafts. The device (2.2) has a precise concentricity within a tolerance of 0.01 mm. The minimum wall thickness in steel is 14 mm, the max wall thickness is 20 mm. After mechanical completion in steel, the raw print cylinder is plated and copper plated in the electroplating process. Next, the copper layer minimum 0.2 mm is polished and a surface roughness (Rz) of 0.45 μm with tolerance+/−0.10 μm finalized. The copper hardness of the copper layer is 220 HV with a tolerance of ±10 HV. The max cylinder width is minimum range 500-1250 mm with a circumference range from 300 mm to 750 mm. The microns are burned into the copper layer of the printing cylinder with a laser exposure having a resolution in the range of 1 nm to 30 μm, where the microns have a depth in the range of 5 μm to 90 μm, and a diameter in the range of 5 μm to 90 μm. This imaging pattern is made from a laser with the resolution minimum 2-12 microns. The imaging source code and laser sequence for the laser machine is defined in software owned from the inventors. The average density of microns ranges from 500-1,000,000 per square centimeter, and the shape of the microns can be suitably formed to a variety of planar geometries. The depth of each micron ranges from 10 μm to 200 μm. To complete the process of the print cylinder with microns a chromium layer is applied. The chromium layer/strength is 4 μm-6 μm and also has a roughness of 0.45 μm, with tolerance of 0.10 μm, the range is 0.35 μm-0.55 μm. The minimum chrome hardness in Vickers is 600 HV and a roughness in the range of 0.25 Rz to 0.65 Rz. The cylinder can also be based on other materials such as stannic, zinc, brass, carbon, ceramic or synthetic substances. The outer layer can be based on brass, ceramic, chrome or other synthetics.

Description of the Printing Process

The standard substrate (3.5) such as Polyethylene terephthalate (PET), Polyethylene (PE), OPP Oriented Polypropylene (OPP), Polypropylen (PP), or Polyethylene Terephthalate Polyester (PETP) has a certain density and resistance. The ink is printed via the printing cylinder (3.1) in a standard rotogravure process to the substrate. The ink is applied from the microns (3.3) on the printing cylinder (3.1). The flow of the substrate is illustrated for the print flow (3.4).

The water based ink absorption is in the range of 0.1 up to 0.2 sec, enriched with soot and fine metal pigments to absorb infrared light to perforate holes into the substrate due to heat generation. The result of the ink applied via the printing cylinder to the substrate are patterns which can be in the geometrical form of rectangle, triangle, hexagon, square, oval, ellipse, trapezoid, rhombus, parallelogram and circle shape. The shape of these patterns are the responsible for the flow of the electrical partials.

The Laser Process of the Substrate with Holes

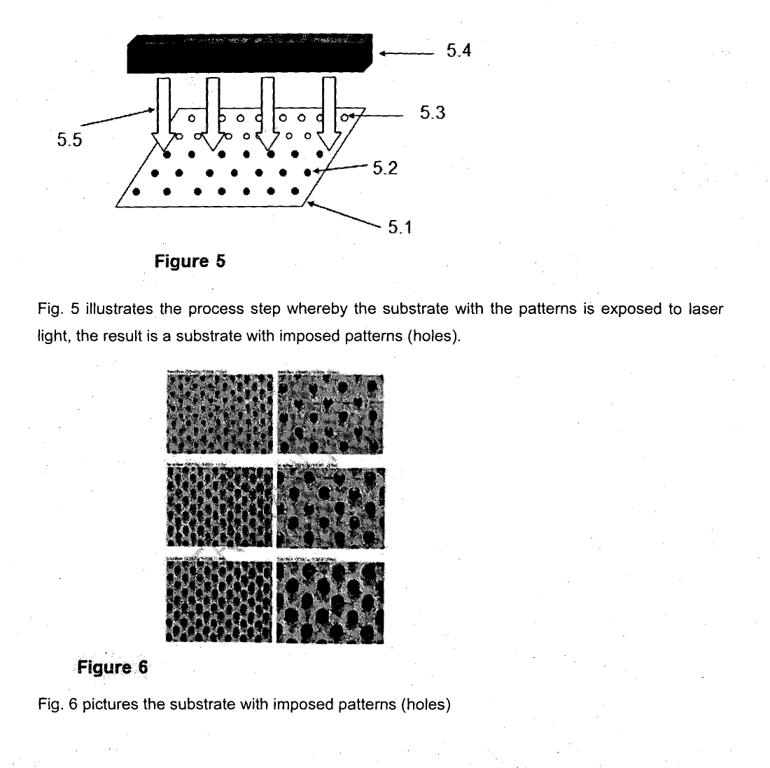

In the last process step in FIG. 5 the substrate with the printed patterns (5.1) is exposed to a laser light (5.5). The laser light bar is beamed from the laser light bar (5.4) onto the inked patterns (5.2). The results are the imposed holes (5.3) in the substrate (5.1). The movement rate of the substrate under the laser bar (5.4) exposure is in range of 5 meter per minute up to 200 meters per minute. The laser light (5.5) reacts with the water-based ink and imposes holes into the substrate. The laser intensity of the infrared light must be evenly and stable over the entire length of the bar (5.4). The perforate holes can also be achieves with other methods such as common laser technologies, however these technologies with a resolution of 1 nanometer 20 μm are not able to achieve the economic of scale to produce the perforated substrate. Other than infrared laser technologies can be used to burn holes into the substrate. These technologies can be for example: Laser technology appellation, Nano printing, Imprinting, Femto laser, Picosecond laser, Pulse laser.

The targeted usage of the mentioned invention is the usage for Lithium-ion battery separators. Separators play a key role in all batteries. Their main function is to keep the positive and negative electrodes apart to prevent electrical short circuits and at the same time allow rapid transport of ionic charge carriers that are needed to complete the circuit during the passage of current in an electro-chemical cell. The substrate has the chemical characteristics to function best in lithium ion batteries. The general battery separator requirements (USABC, 2001)) are based on,

Thickness is important because of the influence to mechanical strength. Current consumer electronics have separators (<25 μm), EV/HEV applications thicker (˜40 μm) separators. Thick separators have the disadvantage of a smaller amount of electrical particles can flow thru. Thinner separators take up less space and permit the use of longer electrodes. This increased both capacity and, by increasing the interfacial area, rate capability. The thinness also makes it a low resistance separator. Permeability typically increases the effective resistivity of the electrolyte by a factor of 6-7 in the battery. Gurley (Air Permeability) is proportional to electrical resistivity, for a given separator morphology. It can be used in place of electrical resistance (ER) measurements once the relationship between gurley and ER is established. The separator should have low gurley values for good electrical performance. The porosity is implicit in the permeability requirement with current separators ranging between 40%-60%. Chemical Stability of the separators should be stable in the battery for a long period of time. This could be implicated from temperatures as high as 75° C. The mechanical stress resistance must protect the separator during manufacturing process, and in the assembly process of the battery itself. This includes also the mixed penetration strength during the winding of the spiral wrap construction considerable mechanical pressure is applied to the cathode-separator-anode interface. The thermal stability of lithium-ion batteries can be poisoned by water, and so materials going into the cell are typically dried at 80° C. under vacuum. Under these conditions, the separator must not shrink significantly and definitely must not wrinkle. The requirement of less than 5% shrinkage after 60 min at 90° C. (in a vacuum) in both MD and TD direction is a reasonable generalization. The pore size is a key requirement of separators for lithium batteries is that their pores be small enough to prevent dendritic lithium penetration through them. The above inventions ranges of the pores are in the range of 5 μm to 90 μm. The tensile strength of the separator is wound with the electrodes under tension. The separator must not elongate significantly under tension in order to avoid contraction of the width.

The perforated substrate can be used in electronic components including separators in lithium-ion batteries, capacitor, super capacitor, or energy storage devices. Furthermore is the usage possible within packaging material for food, or as breathable packaging, or is used as a material to handle perishable groceries, or is used as a filter membrane, or is used as sailcloth.

### PATENT CITATIONS

| | Filing | Publication | | |
|---|---|---|---|---|
| Cited Patent | date | date | Applicant | Title |
| EP 0618629 A1. | Mar. 30, | Oct. 5, 1994 | W.R. GRACE & | Battery separator |
| | 1994 | | CO.-CONN. | |
| WO2012162168 | May 18, | Nov. 29, 2012 | Dreamweaver | Single-layer lithium ion battery |
| A1 | 2012 | | International, Inc. | separator |
| U.S. Pat. No. 3,097,975 A | May 17, | May 17, 1960 | Varta Ag | Separator for electric batteries |
| | 1960 | | | |
| US20090169984 | Nov. 19, | Jul. 2, 2009 | Byd | Company Composite separator films for |
| A1 | 2008 | | Limited | lithium-ion batteries |

Arora, P. and Zhang. Z. (2004) ‘Battery Separators’, Chemical Review V104, pp. 4419-4462.

United States Advanced Battery Consortium, USABC (2001) ‘Development of low cost separators for lithium-ion batteries’, RFPI 2001.

What is claimed is:

1. The process of manufacturing a perforated substrate comprising preparation of a printing cylinder, application of an ink to the substrate with the said printing cylinder, and subsequently exposing the ink pattern with laser light to perforate holes into the substrate.

2. A perforated substrate manufactured using the process of claim 1.

3. Claim 2, wherein the perforated substrate is applied with an electrical device.

4. Claim 2, wherein the perforated substrate is applied within packaging material for food, or as breathable packaging, or is used as a material to handle perishable groceries, or is used as a filter membrane, or is used as sailcloth.

5. Claim 2, wherein the printed pattern on the substrate is used to specify the perforation density and shape.

6. Claim 2, wherein the perforated substrate is used as a separator in a lithium ion battery.

7. Claim 2, wherein the perforated substrate has a characteristic heat resistance in the range of 130-150 Celsius, a tension resistance in the range of 1 NM-50 NM, a thickness in the range of 2 μm-50 μm, an average hole density in a range of 500-10,000 per square centimeter, and an average hole diameter of 30 μm-90 μm.

8. Claim 2, wherein the planar geometry of the holes may be suitably formed to conform to a variety of shapes. The shapes control the flow of the electrical particles, whereby a circle is used for optimal flow.

9. Claim 2, wherein the perforated substrate is used to establish control of the charge flow characteristics within an electrical device.

10. Claim 9, wherein the electrical device is an electronic component including a separator in lithium-ion batteries, capacitor, super capacitor, or energy storage devices.

11. The use of a water based ink enriched with soot and fine metal pigments to absorb infrared light to perforate holes into the substrate due to heat generation.

12. A manufacturing process to produce a printing cylinder with a length in the range of 250 mm up to 1500 mm and a circumference in the range of 200 mm to 900 mm, which involves producing microns in the outer layer of said cylinder with an optical source, and subsequently applying an outer metallic layer to the said cylinder with a thickness in the range of 3 μm-10 μm, and subsequently coating the resulting said cylinder with chrome having a hardness in the range of 50-900 HV and a roughness in the range of 0.15 Rz to 0.75 Rz.

13. Claim 12, wherein the microns are embossed into the copper layer of the printing cylinder with a laser exposure having a resolution in the range of 1 nm to 30 μm, where the microns have a depth in the range of 5 μm to 90 μm, and a diameter in the range of 5 μm to 90 μm, where said chrome layer has a minimum hardness of 600 HZ and a roughness in the range of 0.25 Rz to 0.65 Rz.

14. Claim 12, wherein the average density of microns ranges from 500-1,000,000 per square centimeter, and the shape of the microns can be suitably formed to a variety of planar geometries.

15. Claim 12, wherein the fabrication process of the cylinder is used to establish a specific print pattern of microns for transfer onto the perforated substrate.

16. The use of an infrared laser bar to impose a pattern of holes on to the substrate by thermodynamic reaction of the printed ink pattern with the said laser light.

17. Wherein the print patterns of the said perforated substrate applied from the said printing cylinder and the ink have the regular array of circular objects. These objects control the flow of electrical particles with the highest performance.

18. The optimized procedure of a manufacturing process to perforate holes into a substrate.
